(19) United States
(12) Patent Application Publication
(10) Pub. No.: US 2011/0309920 A1
(43) Pub. Date: Dec. 22, 2011

(54) TACTILE PROMPTING SYSTEM AND METHOD FOR TACTUALLY PROMPTING AN OPERATOR OF A RAIL VEHICLE

(76) Inventor: James D. BROOKS, (US)

(21) Appl. No.: 12/819,593

(22) Filed: Jun. 21, 2010

(51) Int. Cl. G08B 6/00

(52) U.S. Cl. 340/407.2

(57) ABSTRACT

A tactile prompting system includes a control module that forms an instruction to prompt an operator of a powered rail vehicle to take an action in response thereof, an input device of the powered rail vehicle that is configured to be actuated by the operator, and a haptic feedback device communicatively coupled with the control module and coupled with the input device. The haptic feedback device receives the instruction from the control module and provides a haptic signal to the operator based on the instruction. The haptic signal is tactually perceived by the operator.

### BACKGROUND OF THE INVENTION

The subject matter described herein relates generally to powered rail vehicles.

Known railway systems include rail vehicles that travel along one or more rails of a track. A group of rail vehicles that are mechanically connected to travel together along a track is referred to as a rail vehicle consist. A consist may include one or more powered units, such as locomotives, and one or more trailing units, such as passenger and/or cargo cars. The powered units include motors that provide tractive effort to propel the powered and trailing units along the track. A human operator modifies the net tractive effort of the powered units by changing the power command of an engine of the powered unit and/or applying or disengaging dynamic or air brakes of the rail vehicle, thus modifying the net braking effort.

Some known rail vehicles include computerized systems that recommend a speed and/or tractive effort of the powered unit during a trip along the track. The computerized systems may use a predetermined speed and/or power profile that recommends the speed and/or tractive effort of the rail vehicle throughout the trip. During the trip, the computerized system visually prompts the operator to change a speed and/or tractive effort of the rail vehicle. For example, if the rail vehicle is travelling faster than the speed recommended by the speed profile, the computerized system may visually display an instruction to the operator that directs the operator to decrease an engine throttle and/or apply a brake to reduce the speed of the rail vehicle. Alternatively, if the rail vehicle is travelling slower than the speed recommended by the speed profile, the computerized system may visually display an instruction to the operator that directs the operator to increase an engine throttle and/or release a brake to increase the speed of the rail vehicle.

Some known computerized systems include safety features that ensure that the operator of the rail vehicle is alert and attentive at the controls of the rail vehicle. For example, some known systems include alerter buttons that must be periodically actuated by the operator to ensure that the operator is alert and attentive to the controls. Failure to actuate the alerter buttons within a predetermined time period can result in the brakes of the rail vehicle being automatically engaged. For example, if the operator has not changed the throttle, engaged a brake, or released a brake within a predetermined time period, the computerized system may visually and/or audibly prompt the operator to press the alerter button. Failure of the operator to press the alerter button may cause the computerized system to engage the brakes and stop the rail vehicle.

The visual instructions from the computerized systems are provided on displays in the powered unit. The windows of the powered units of a rail vehicle tend to be relatively small and limit the field of view that the operators have of the environment outside of the rail vehicle. In order to ensure that the operator is following the instructions, the operator must periodically look away from the relatively small window and toward the display. For example, the operator may be required to look away from the window and toward the display at least once very three to ten seconds. The more often that the operator looks away from the window increases the time that the operator's attention is not focused on the track ahead of the rail vehicle. As the operator's attention is focused away from the track, the risk of an accident involving the rail vehicle may increase.

A need exists for a system and method that prompts an operator of a rail vehicle to change the speed and/or power of a rail vehicle without requiring the operator to frequently look away from the window of the rail vehicle.

### BRIEF DESCRIPTION OF THE INVENTION

In one embodiment, a tactile prompting system is provided. The tactile prompting system includes a control module that forms an instruction to prompt an operator of a powered rail vehicle to take an action in response thereof, an input device of the powered rail vehicle that is configured to be actuated by the operator, and a haptic feedback device communicatively coupled with the control module and coupled with the input device. The haptic feedback device receives the instruction from the control module and provides a haptic signal to the operator based on the instruction. The haptic signal is tactually perceived by the operator.

In another embodiment, a tactile prompting method is provided. The method includes determining when to instruct an operator of a powered rail vehicle to take an action related to the rail vehicle, communicating an instruction to a haptic feedback device that is coupled with an input device of the powered rail vehicle, and, based on the instruction, providing a haptic signal using the haptic feedback device, the haptic signal tactually perceived by the operator to prompt the operator to actuate the input device in response thereto for taking the action related to the rail vehicle.

### BRIEF DESCRIPTION OF THE DRAWINGS

FIG. 1 is a diagram of a rail vehicle consist in accordance with one embodiment.

FIG. 2 is a diagram of an engine throttle shown in FIG. 1 in accordance with one embodiment.

FIG. 3 is a diagram of a dynamic brake handle shown in FIG. 1 in accordance with one embodiment.

FIG. 4 is a diagram of an air brake handle shown in FIG. 1 in accordance with one embodiment.

FIG. 5 is a diagram of a reset actuator shown in FIG. 1 in accordance with one embodiment.

FIG. 6 is a diagram of a wearable input device in accordance with one embodiment.

FIG. 7 is a flowchart of a tactile prompting method for tactually prompting an operator of the rail vehicle shown in FIG. 1 to take an action in accordance with one embodiment.

### DETAILED DESCRIPTION OF THE INVENTION

The foregoing summary, as well as the following detailed description of certain embodiments of the presently described subject matter, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It should be noted that although one or more embodiments may be described in connection with powered rail vehicle systems having locomotives with trailing passenger cars, the embodiments described herein are not limited to passenger trains or other trains. In particular, one or more embodiments may be implemented in connection with different types of rail vehicles and other non-rail vehicles. For example, one or more embodiments may be implemented with a vehicle that travels on one or more rails, such as single locomotives and railcars, powered ore carts and other mining vehicles, light rail transit vehicles, and the like. Alternatively, one or more embodiments may be implemented with non-rail vehicles such as automobiles and other vehicles capable of self-propulsion.

Example embodiments of prompting systems and methods for prompting an operator of a powered rail vehicle to take an action, such as change a speed of the rail vehicle, apply a brake of the rail vehicle, reset a periodically activated alert device, and the like, are provided. At least one technical effect described herein includes a system and method that tactually prompts an operator of a rail vehicle to take an action relating to the rail vehicle using a haptic feedback device that is coupled to an input device of the rail vehicle. By providing tactile prompts, the operator can keep his or her eyes and attention focused on the rail(s) ahead of the rail vehicle, as opposed to periodically having to divert his or her gaze to a display screen or other visual prompt.

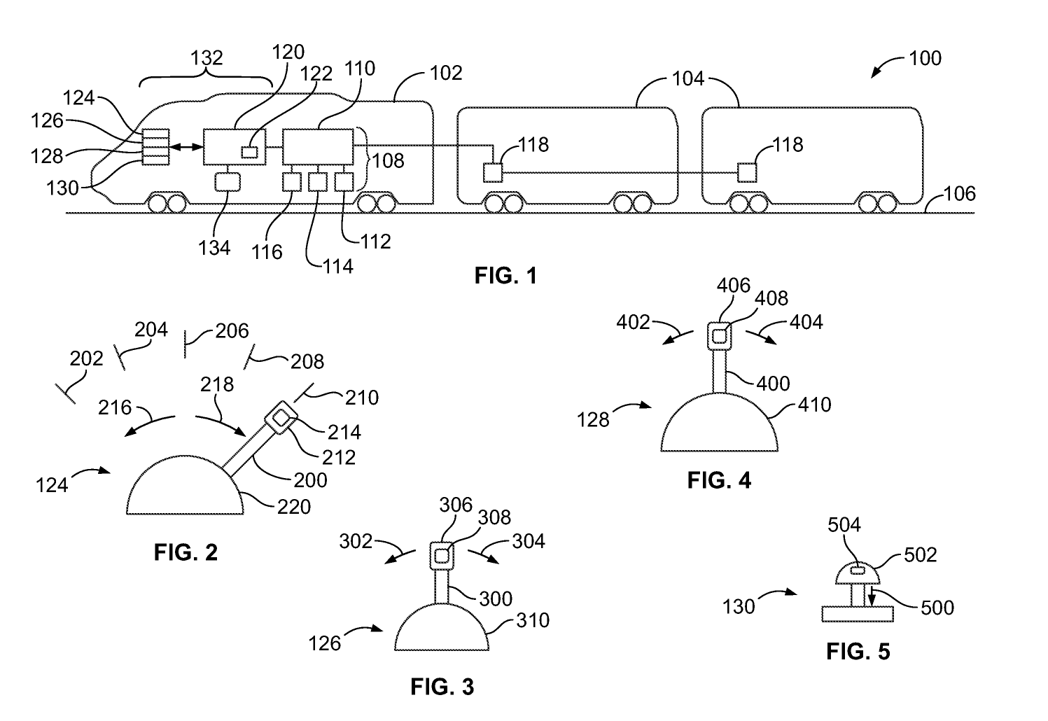

FIG. 1 is a diagram of a rail vehicle 100 (e.g., rail vehicle consist) in accordance with one embodiment. The rail vehicle 100 includes a powered unit 102 coupled with several trailing units 104 that travel along one or more rails 106. The powered unit 102 may be a locomotive while the trailing units 104 may be passenger cars for carrying passengers and/or storage units (load units) for carrying goods along the rail(s) 106. The powered unit 102 includes an on-board propulsion subsystem 108 that provides tractive effort to propel the rail vehicle 100. In the illustrated embodiment, the propulsion subsystem 108 includes an engine 110 that may be coupled with an alternator (not shown) to create electric current that is supplied to one or more traction motors 112. The traction motors 112 rotate wheels of the rail vehicle 100 to propel the rail vehicle 100. Alternatively, the propulsion subsystem 108 may include circuits that receive electric current from an external source, such as an overhead catenary or a powered rail, and supply the current to the traction motors 112 to propel the rail vehicle 100.

The engine 110 may increase or decrease the tractive effort to speed up or slow down the speed of the rail vehicle 100. In the illustrated embodiment, the rail vehicle 100 also includes brakes 114, 116, 118 that supply braking effort to slow the rail vehicle 100. The brakes 114, 116, 118 include a dynamic brake 114 that is activated to decrease the net tractive effort applied to the rail vehicle 100 and slow down the rail vehicle 100. The dynamic brake 114 may be a regenerative brake that creates regenerative current when the rail vehicle 100 slows down. The brakes 114, 116, 118 also include air brakes 116, 118. The air brake 116 is disposed in the powered unit 102 while the air brakes 118 are disposed in the trailing units 104. The air brakes 116, 118 are engaged or actuated to increase the net braking effort of the rail vehicle 100 to slow down or stop the rail vehicle 100.

A tactile prompting system 132 is coupled with the propulsion subsystem 108 and/or brakes 114, 116, 118. The prompting system 132 includes a control module 120 that is communicatively coupled with the propulsion subsystem 108 and/or brakes 114, 116, 118. For example, the control module 120 may be communicatively coupled with the propulsion subsystem 108 and/or brakes 114, 116, 118 by wired and/or wireless connections. The control module 120 may be or include a processor, such as a computer processor, controller, microcontroller, or other type of logic device, that operates based on sets of instructions stored on a tangible and non-transitory computer readable storage medium 122. The computer readable storage medium 122 may be an electrically erasable programmable read only memory (EEPROM), simple read only memory (ROM), programmable read only memory (PROM), erasable programmable read only memory (EPROM), FLASH memory, a hard drive, or other type of computer memory.

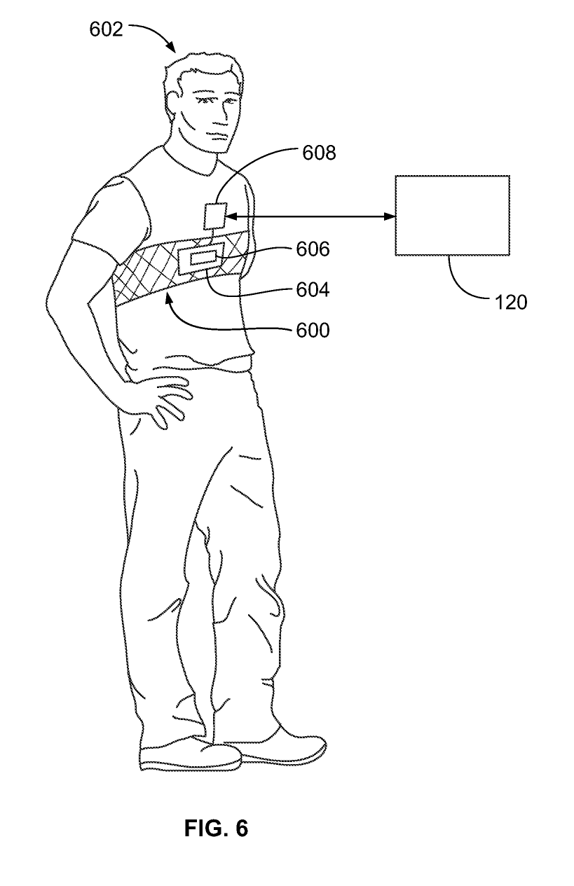

The control module 120 interfaces with input devices 124, 126, 128, 130 of the prompting system 132. While the prompting system 132 is shown as including the input devices 124, 126, 128, 130, the prompting system 132 may alternatively include a different number and/or type of input devices 124, 126, 128, 130. In one embodiment, the input devices 124, 126, 128, 130 are coupled with the propulsion subsystem 108 and are actuated by a human operator 602 (shown in FIG. 6) of the rail vehicle 100 to take one or more actions related to the rail vehicle 100. For example, the input devices 124, 126, 128, 130 may be actuated to modify or maintain the tractive effort supplied by the propulsion subsystem 108, the braking effort supplied by the brakes 114, 116, 118, to change the rail(s) 106 upon which the rail vehicle 100 is travelling, and the like. In the illustrated embodiment, the input devices 124, 126, 128, 130 include an engine throttle 124, a dynamic brake handle 126, an air brake handle 128, and a reset actuator 130. The engine throttle 124 is manually actuated by the operator 602 in the powered unit 102 to increase or decrease a power command of the engine 120 and/or the tractive effort of the propulsion subsystem 108. The power command of the engine 120 represents a setting of the engine 120 that is based on a position of the engine throttle 124. In one embodiment, the engine throttle 124 is moveable between several positions 202, 204, 206, 208, 210 (shown in FIG. 2). The different positions 202, 204, 206, 208, 210 are mapped or otherwise associated with a torque that is generated by the engine 120, or a speed and/or power at which the engine 120 rotates a shaft. The operator may move the engine throttle 124 among the positions 202, 204, 206, 208 to change the torque, or speed and/or power, of the engine 120. The dynamic brake handle 126 is manually actuated by the operator 602 to engage the dynamic brake 114, which slows down the rail vehicle 100 and increases the net braking effort of the rail vehicle 100. The air brake handle 128 is manually actuated to engage one or more of the air brakes 116, 118, which also slows down the rail vehicle 100 and increases the net braking effort of the rail vehicle 100.

The reset actuator 130 is manually actuated to reset a timer that applies the dynamic and/or air brakes 114, 116, 118 when the timer expires. For example, the prompting system 132 may include a safety measure that includes a timer counting down from a predetermined amount or time after the operator 602 (shown in FIG. 6) has last performed an action such as changing a setting of the engine throttle 124 and/or engaging the dynamic and/or air brakes 114, 116, 118. If the timer reaches zero without the reset actuator 130 being engaged or actuated, the dynamic and/or air brakes 114, 116, 118 are automatically engaged to stop the rail vehicle 100.

The prompting system 132 uses haptic signals to notify the operator 602 (shown in FIG. 6) when to change the tractive or braking effort of the rail vehicle 100. The haptic signals may be communicated to the operator 602 through haptic feedback devices 212, 306, 406, 502 (shown in FIGS. 2, 3, 4, 5, and 6) that are coupled with the input devices 124, 126, 128, 130. The haptic signals are tactually perceived by the operator 602. The operator 602 may recognize communication of the haptic signals using the operator's sense of touch, as opposed to the operator's sight or other senses. For example, the prompting system 132 may communicate a haptic signal using vibrations, temperature changes, or other tactile methods of communication, which are conveyed or communicated to the operator 602 through the input devices 124, 126, 128, 130. The haptic signals can be communicated to the operator 602 when feedback is required from the operator 602. For example, the control module 120 may provide a haptic signal to the operator 602 to prompt the operator 602 to actuate the engine throttle 124 and speed up or slow down the rail vehicle 100, to actuate the brake handle 126 and/or 128 to slow down the rail vehicle 100, and/or to actuate the reset actuator 130.

In one embodiment, the control module 120 determines when the operator 602 (shown in FIG. 6) is to be prompted to take an action related to the rail vehicle 100. For example, the control module 120 may determine when the tractive effort supplied by the propulsion subsystem 108 needs to change, the braking effort supplied by the brakes 114, 116, 118 needs to change, and/or some other action needs to be taken. For example, the control module 120 may determine a speed profile for the rail vehicle 100 over a predetermined trip or route. The speed profile may be based on a variety of factors, including the grade of the rail(s) 106 over the trip, the character of the trip (for example, through a rural area versus through an urban area), the grade of the rail(s) 106, the mass of the rail vehicle 100 and cargo, and the like. Based on the speed profile, the control module 120 may periodically direct the operator 602 (shown in FIG. 6) to change the net tractive effort supplied by the propulsion subsystem 108 during the trip. The control module 120 may direct the operator 602 to increase or decrease the power command of the engine 110 and/or apply the dynamic and/or air brakes 114, 116, 118 based on the speed profile and using one or more haptic signals. In one embodiment, the speed profile is determined by a Trip Optimizer™ or Trip Advisor™ system provided by General Electric Company.

In another embodiment, the control module 120 determines when the operator 602 (shown in FIG. 6) needs to respond to a visual prompt or signal. For example, the control module 120 may be communicatively coupled with a display device 134. The display device 134 may include a CRT monitor, an LCD screen, or some other device capable of visually presenting information to the operator 602. The control module 120 may provide visual instructions on the display device 134 that direct the operator 602 to take one or more actions, such as changing from one rail 106 to another rail 106, changing the tractive or braking effort, actuating the reset actuator 130, press a button displayed on the display device 134, and the like. If the operator 602 does not take the action that is visually instructed or requested by the control module 120 within a predetermined time period, the control module 120 may tactually prompt the operator 602 to take the requested action by communicating one or more haptic signals to the operator 602.

Alternatively, the tactile prompting system 108 may include a plurality of control modules 120. For example, the tactile prompting system 108 may include control modules 120 dedicated or associated with different functions. A first control module 120 may determine when the rail vehicle 100 has deviated from a predetermined speed and/or power profile, a second control module 120 may determine when the reset actuator 130 needs to be engaged, a third control module 120 may determine which rail(s) 106 the rail vehicle 100 is to travel on, and so forth. In some circumstances, two or more of the control modules 120 may concurrently or simultaneously generate instructions for the same input device 124, 126, 128, 130. For example, both the first and third control modules 120 may determine that the input devices 126, 128 need to be actuated in order to stop movement of the rail vehicle 100. In such an embodiment, the control modules 120 may communicate the instructions from the respective control modules 120 according to a predetermined priority scheme. For example, the instructions from the second control module 120 may take precedence over instructions from the third control module 120, and the instructions from the third control module 120 may take precedence over the instructions from the first control module 120. If multiple control modules 120 determine to concurrently send multiple instructions to the same input device 124, 126, 128, 130, one or more of the control modules 120 may delay sending the instruction until the instructions of the higher-priority control modules 120 are communicated. Alternatively, one or more of the control modules 120 that is sending the same or similar instruction as another control module 120 to the same input device 124, 126, 128, 130 may withhold communication of the redundant instruction.

FIG. 2 is a diagram of the input device 124 (for example, the engine throttle 124) in accordance with one embodiment. The engine throttle 124 may be an elongated handle 200 that is actuated between the multiple positions 202, 204, 206, 208, 210 to change the tractive effort produced by the engine 110 (shown in FIG. 1). For example, the engine throttle 124 may be communicatively coupled with the engine 110 through wired and/or wireless connections. Pivoting of the handle 200 from one position 202, 204, 206, 208, 210 to another position 202, 204, 206, 208, 210 increases or decreases the power command of the engine 110 (e.g., notch level), such as the torque with which the engine 110 rotates a shaft (not shown) to which an alternator or generator (not shown) is joined. Changing the torque at which the shaft is rotated changes the electric current produced by the alternator or generator and supplied to the traction motors 112 (shown in FIG. 1). Changing the current supplied to the traction motors 112 changes the torque at which the traction motors 112 propel the rail vehicle 100 (shown in FIG. 1).

The engine throttle 124 includes a haptic feedback device 212 that is communicatively coupled with the control module 120 (shown in FIG. 1). For example, the haptic feedback device 212 may communicate with the control module 120 through one or more wired and/or wireless connections, such as wires that extend through the handle 200 to the control module 120. In the illustrated embodiment, the haptic feedback device 212 is coupled to the handle 200 in a position where the operator 602 (shown in FIG. 6) is likely to grasp the handle 200 in order to move the handle 200 between positions 202, 204, 206, 208, 210.

The haptic feedback device 212 delivers haptic signals to the operator 602 (shown in FIG. 6) based on instructions received from the control module 120 (shown in FIG. 1). For example, when the control module 120 determines that the tractive effort supplied by the propulsion subsystem 108 (shown in FIG. 1) is to be changed based on a predetermined speed and/or power profile of a trip, the control module 120 may communicate an instruction to the haptic feedback device 212. Based on the instruction, the haptic feedback device 212 communicates the haptic signal to the operator 602 as a prompt to change the position 202, 204, 206, 208, 210 of the handle 200. The instruction may be communicated to the haptic feedback device 212 if the rail vehicle 100 is moving too fast or too slow relative to the speed and/or power profile of the trip.

In another example, the instructions communicated to the haptic feedback device 212 may be based on a Positive Train Control (PTC) system. In this case, the control module 120 is or includes the PTC system. This PTC system monitors a position of the rail vehicle 100 (shown in FIG. 1) to determine on which rail(s) 106 (shown in FIG. 1) the rail vehicle 100 is travelling and if the rail vehicle 100 is allowed to travel along the rail(s) 106. The PTC system monitors the locations of the rail vehicle 100 to prevent the rail vehicle 100 from travelling along a portion of a rail(s) 106 on which another rail vehicle 100 is travelling. If the control module 120 (shown in FIG. 1) determines that the rail vehicle 100 is traveling along a rail(s) 106 that the rail vehicle 100 is not allowed to travel on, the control module 120 may communicate instructions to the haptic feedback device 212. The haptic feedback device 212 may provide haptic signals to the operator 602 to cause the operator 602 to slow down and/or stop the rail vehicle 100.

The haptic signal is capable of being tactually perceived by the operator 602 (shown in FIG. 6). In one embodiment, the haptic signal is a vibration of the haptic feedback device 212. For example, the haptic feedback device 212 may include a mass 214 that is a vibratory mass. The vibratory mass 214 moves relative to the haptic feedback device 212 and/or the handle 200 in response to the haptic feedback device 212 receiving the instruction from the control module 120 (shown in FIG. 1). The movement of the vibratory mass 214 causes vibration of the haptic feedback device 212 as the haptic signal. The operator 602 feels the vibration of the haptic feedback device 212 as the haptic signal and changes the position 202, 204, 206, 208, 210 of the handle 200.

The vibration of the haptic feedback device 212 may vary based on the instruction received from the control module 120 (shown in FIG. 1). For example, the frequency of the movement of the vibratory mass 214 and/or the magnitude or amplitude of the vibrations generated by the vibratory mass 214 may be based on the instruction from the control module 120. The frequency and/or amplitude of the vibrations caused by the vibratory mass 214 can be based on the number of positions 202, 204, 206, 208, 210 that the instruction from the control module 120 directs the handle 200 to be moved. For example, if the instruction directs the handle 200 to be moved from the position 206 to the position 202, the frequency and/or magnitude of the vibrations caused by the vibratory mass 214 may be greater than the frequency and/or magnitude of the vibrations if the instruction directs the handle 200 to be moved from the position 206 to the closer position 204. Similarly, the frequency and/or magnitude of the vibrations may increase as the elapsed time from the start of prompt increases. For example, the frequency and/or magnitude of the vibration of the mass 214 may increase the longer that the haptic signal is supplied to the operator 602 until the operator 602 provides the input or takes an action requested by the haptic signal. The instruction can direct the haptic feedback device 212 to generate a pulse of multiple vibrations or vibration parts based on the instruction. For example, the vibratory mass 214 may generate a series of vibrations within a predetermined time based on the instruction. The number, frequency, and/or magnitude of the vibrations, and/or the period of time in which the vibrations are created, may be based on the instruction.

In another embodiment, the haptic signal is a change in temperature of the haptic feedback device 212. For example, the mass 214 may be a thermally conductive body that changes temperature in response to the instruction received from the control module 120 (shown in FIG. 1). The mass 214 may heat up or cool down based on the instruction. In one embodiment, the change in temperature of the mass 214 is based on the instruction. For example, if the instruction directs the handle 200 to be moved in one direction 216, the mass 214 may heat up while if the instruction directs the handle 200 to be moved in another direction 218, the mass 214 cools down.

The change in temperature may be based on how many positions 202, 204, 206, 208, 210 that the instructions direct the handle 200 to be moved. For example, the mass 214 may heat up or cool down by a greater number of degrees when the instruction directs the handle 200 to be moved between a greater number of positions 202, 204, 206, 208, 210. Conversely, the mass 214 may heat up or cool down by a lesser number of degrees when the instruction directs the handle 200 to be moved between a lesser number of positions 202, 204, 206, 208, 210.

In another embodiment, the engine throttle 124 includes a haptic feedback device 220 that controls a physical resistance to movement of the handle 200. For example, the haptic feedback device 220 may be a base to which the handle 200 is joined, with the handle 200 moving relative to the haptic feedback device 220 among the positions 202, 204, 206, 208, 210. The haptic feedback device 220 may vary the physical resistance to moving the handle 200 based on the instructions received from the control module 120 (shown in FIG. 1). For example, the haptic feedback device 220 may permit the handle 200 to be moved in the direction 216 with less effort by the operator 602 (shown in FIG. 6) than movement of the handle 200 in the direction 218 based on the instruction from the control module 120. The operator 602 perceives the change in physical resistance to movement of the handle 200 as the haptic signal.

The haptic feedback device 220 may initiate movement of the handle 200 in one direction 216 or 218 based on the instruction from the control module 120 (shown in FIG. 1). For example, if the instruction from the control module 120 directs the handle 200 to be moved in the direction 216, the haptic feedback device 220 may move the handle 200 toward the next position 202, 204, 206, 208, 210 in the direction 216. The operator 602 (shown in FIG. 6) perceives or feels this movement as the haptic signal.

FIG. 3 is a diagram of the input device 126 (for example, the dynamic brake handle 126) in accordance with one embodiment. The dynamic brake handle 126 may be an elongated handle 300 that is actuated along different directions 302, 304 to change the net braking effort of the rail vehicle 100 (shown in FIG. 1). For example, the dynamic brake handle 126 may be communicatively coupled with the dynamic brakes 114 (shown in FIG. 1) through wired and/or wireless connections. Pivoting the handle 300 in one direction 302 may apply the dynamic brakes 114 to increase the net braking effort of the propulsion subsystem 108 (shown in FIG. 1) and slow down the rail vehicle 100. Pivoting the handle 300 in another direction 304 may release the dynamic brakes 114 to decrease the net braking effort.

The dynamic brake handle 126 may be an analog input device. For example, the handle 300 can be moved in directions 302, 304 by varying distances without being moved between discrete positions. In one embodiment, the change in net braking effort caused by movement of the handle 300 is based on the distance that the handle 300 is moved in the directions 302, 304. For example, moving the handle 300 farther in the direction 302 increases the net braking effort a greater amount than moving the handle 300 a shorter distance in the direction 302.

The dynamic brake handle 126 includes a haptic feedback device 306 joined to the handle 300 in the illustrated embodiment. Similar to the haptic feedback device 212 (shown in FIG. 2), the haptic feedback device 306 may include a mass 308 that is a vibratory mass and/or a thermally conductive body. As described above, the mass 308 may move and/or change temperature to provide a haptic signal based on instructions received from the control module 120 (shown in FIG. 1). The operator 602 (shown in FIG. 6) perceives the haptic signal provided by the mass 308 and actuates the dynamic brake handle 126 in response thereto.

The dynamic brake handle 126 may include a haptic feedback device 310 joined to the handle 300. Similar to the haptic feedback device 220 (shown in FIG. 2), the haptic feedback device 310 can change the physical resistance to moving the handle 300 in the direction 302 and/or 304 based on the instructions received from the control module 120 (shown in FIG. 1). In one embodiment, the haptic feedback device 310 may move the handle 300 in the direction 302 or 304 based on the instructions received from the control module 120.

FIG. 4 is a diagram of the input device 128 (for example, the air brake handle 128) in accordance with one embodiment. The air brake handle 128 may be an elongated handle 400 that is actuated along different directions 402, 404 to change the net friction braking effort of the rail vehicle 100 (shown in FIG. 1). For example, the air brake handle 128 may be communicatively coupled with the air brakes 116, 118 (shown in FIG. 1) through wired and/or wireless connections. The air brake handle 128 may be referred to an automatic air brake handle that causes the air brakes 116, 118 of the powered and trailing units 102, 104 (shown in FIG. 1) to be applied to reduce the speed of the rail vehicle 100 when the air brake handle 128 is actuated. Pivoting the handle 400 in an opposite direction 404 may release the air brakes 116, 118 of the powered and trailing units 102, 104 to slow down the rail vehicle 100. In another embodiment, the air brake handle 128 may be referred to as an individual air brake handle that causes the air brakes 116 of the powered unit 102, but not the air brakes 118 of the trailing units 104, to be engaged when the air brake handle 128 is actuated.

The air brake handle 128 includes a haptic feedback device 406 joined to the handle 400 in the illustrated embodiment. Similar to the haptic feedback devices 212, 306 (shown in FIGS. 2 and 3), the haptic feedback device 406 may include a mass 408 that is a vibratory mass and/or a thermally conductive body. As described above, the mass 408 may move and/or change temperature to provide a haptic signal based on instructions received from the control module 120 (shown in FIG. 1). The operator 602 (shown in FIG. 6) perceives the haptic signal provided by the mass 408 and actuates the air brake handle 128 in response thereto.

The air brake handle 128 may include a haptic feedback device 410 that is joined to the handle 400. Similar to the haptic feedback devices 220, 310 (shown in FIGS. 2 and 3), the haptic feedback device 410 can change the physical resistance to moving the handle 400 in the direction 402 and/or the direction 404 based on the instructions received from the control module 120 (shown in FIG. 1). In one embodiment, the haptic feedback device 410 may move the handle 400 in the direction 402 or 404 based on the instructions received from the control module 120.

FIG. 5 is a diagram of the input device 130 (for example, the reset actuator 130) in accordance with one embodiment. The reset actuator 130 may be plunger, button, switch, or other assembly that is depressed in an activation direction 500. The reset actuator 130 may be actuated to reset a timer of the control module 120 (shown in FIG. 1). The control module 120 may begin a countdown of a timer after the operator 602 changes the tractive effort of the rail vehicle 100 (shown in FIG. 1). For example, after the operator 602 (shown in FIG. 6) actuates the engine throttle 124 (shown in FIG. 1), the dynamic brake handle 126 (shown in FIG. 1), and/or the air brake handle 128 (shown in FIG. 1), the control module 120 can begin counting down from a predetermined time. The operator 602 depresses the reset actuator 130 to reset the timer. If the operator 602 does not actuate the reset actuator 130 before expiration of the timer, then the control module 120 may decrease the power command of the engine 110 (shown in FIG. 1) and/or engage one or more of the dynamic and air brakes 114, 116, 118 (shown in FIG. 1) to slow down and stop the rail vehicle 100. The timer may be used in this way to provide a safety feature that stops the rail vehicle 100 when the operator 602 in inattentive or otherwise unable to control the rail vehicle 100.

The reset actuator 130 includes a haptic feedback device 502. Similar to the haptic feedback devices 212, 306, 406 (shown in FIGS. 2, 3, and 4), the haptic feedback device 502 may include a mass 504 that is a vibratory mass and/or a thermally conductive body. As described above, the mass 504 may move and/or change temperature to provide a haptic signal based on instructions received from the control module 120 (shown in FIG. 1). The operator 602 (shown in FIG. 6) perceives the haptic signal provided by the mass 504 and depresses the reset actuator 130 in response thereto. The instruction may be periodically communicated by the control module 120 and/or communicated prior to expiration of the countdown timer to prompt the operator 602 to actuate the reset actuator 130 and avoid stopping the rail vehicle 100 (shown in FIG. 1).

FIG. 6 is a diagram of a wearable input device 600 in accordance with one embodiment. The wearable input device 600 is shaped to be worn on a body of the operator 602. For example, the wearable input device 600 may be a band that extends around the chest, waist, an arm, leg, or hand of the operator 602. Alternatively, the wearable input device 600 may be formed in another shape, such as a patch, shirt, pair of pants, hat, headband, shoe, sock, and the like. In the illustrated embodiment, the wearable input device 600 is a band wrapped around the chest of the operator 602.

The wearable input device 600 is communicatively coupled with the control module 120. The wearable input device 600 may receive instructions from the control module 120 through one or more wired and/or wireless connections. The wearable input device 600 includes a haptic feedback device 604. Similar to the haptic feedback device 212, 306, 406, 502 (shown in FIGS. 2, 3, 4, and 5), the haptic feedback device 604 may include a mass 606 that is a vibratory mass and/or a thermally conductive body. As described above, the mass 606 may, move and/or change temperature to provide a haptic signal based on instructions received from the control module 120. The operator 602 perceives the haptic signal provided by the mass 606 and actuates one or more of the input devices 124, 126, 128, 130 (shown in FIG. 1) in response thereto.

The wearable input device 600 may be coupled with a physiologic sensor 608. The physiologic sensor 608 measures one or more physiologic parameters of the operator 602 to verify that the operator 602 is wearing the wearable input device 600. For example, the physiologic sensor 608 may include one or more of electrocardiogram (ECG) electrodes that monitors cardiac signals, a respirator sensor that monitors breathing of the operator 602, a blood oxygen sensor that measure the oxygen content of the operator's blood, a capacitive sensor that measures the capacitance of the skin of the operator 602, and the like. The physiologic sensor 608 monitors the physiologic parameters to ensure that the operator 602 is wearing the wearable input device 600. The physiologic parameters are communicated to the control module 120. If the control module 120 determines that the operator 602 is not wearing the wearable input device 600 based on the physiologic parameters, then the control module 120 may decrease the power command of the engine 110 (shown in FIG. 1), apply the dynamic and/or air brakes 114, 116, 118 (shown in FIG. 1), and/or take other actions to stop the rail vehicle 100 or prevent the rail vehicle 100 from moving. In doing so, the control module 120 can prevent the rail vehicle 100 from moving along the rail(s) 106 (shown in FIG. 1) until the operator 602 wears the wearable input device 600.

In another embodiment, another component of the rail vehicle 100 (shown in FIG. 1) includes an input device other than those described above that provides a haptic signal to the operator 602 to prompt the operator 602 to take some action in response thereto. For example, a chair or seat of the operator 602 may include a mass that vibrates and/or changes temperature to prompt the operator 602 to change the tractive effort of the rail vehicle 100 and/or depress the reset actuator 130. The embodiments described herein are provided merely as examples and are not intended to be all encompassing of all potential devices that may provide haptic signals to prompt the operator 602 to take some action in response thereto.

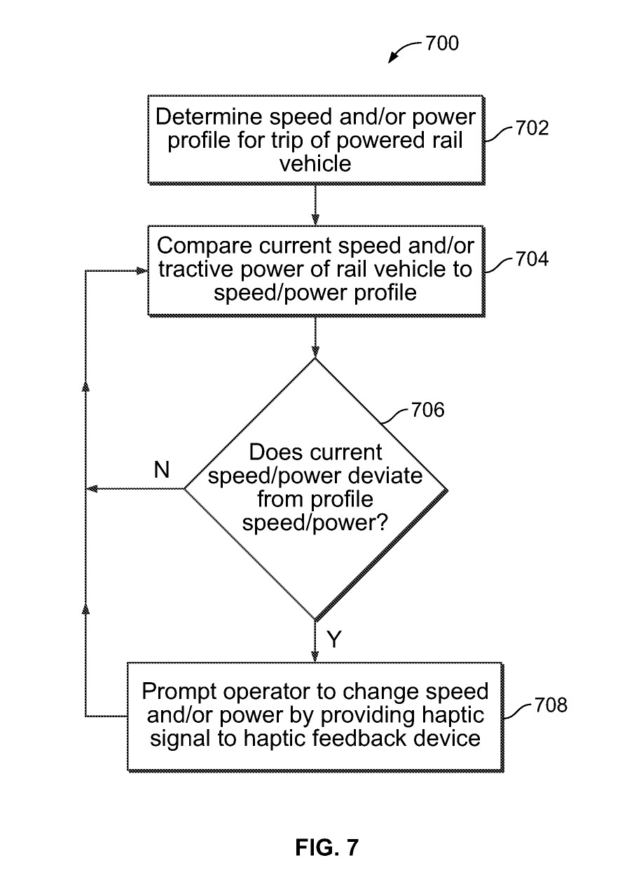

FIG. 7 is a flowchart of a tactile prompting method 700 for tactually prompting the operator 602 (shown in FIG. 6) of the rail vehicle 100 (shown in FIG. 1) to change the speed and/or tractive effort of the rail vehicle 100 in accordance with one embodiment. At 702, a speed and/or power profile (“speed/power profile”) is determined for a trip of the rail vehicle 100. For example, for a trip of the rail vehicle 100 between a beginning location and an ending location, a profile of the speed and/or tractive effort of the rail vehicle 100 is calculated. The speed/power profile recommends a speed and/or tractive effort of the rail vehicle 100 at various locations along the trip based on a variety of factors, including the grade of the rail(s) 106 (shown in FIG. 1), the mass of the rail vehicle 100 and cargo carried by the rail vehicle 100, the curvature of the rail(s) 106, the population density of the areas surrounding the rail(s) 106 (such as whether the area is a densely populated urban area or a sparsely populated rural area), and the like.

At 704, a current speed and/or tractive effort of the rail vehicle 100 (shown in FIG. 1) is compared to the speed/power profile. The current speed and/or tractive effort is the speed and/or tractive effort of the rail vehicle 100 at the current location of the rail vehicle 100 along the trip. The current speed and/or tractive effort is compared to the speed and/or tractive effort that is recommended by the speed/power profile.

At 706, a determination is made as to whether the current speed and/or tractive effort of the rail vehicle 100 (shown in FIG. 1) deviates from the speed and/or tractive effort recommended by the speed/power profile. For example, the control module 120 (shown in FIG. 1) may determine if the current speed and/or tractive effort of the rail vehicle 100 is greater or smaller than the speed and/or tractive effort recommended by the speed/power profile for the current location of the rail vehicle 100. If the current speed and/or tractive effort of the rail vehicle 100 is different from the recommended speed and/or tractive effort of the speed/power profile, then the current speed and/or tractive effort may be changed so that the speed and/or tractive effort matches or is changed to be closer to the speed and/or tractive effort recommended by the speed/power profile. If the current speed and/or tractive effort is different from the recommended speed and/or tractive effort, flow of the method 700 proceeds to 708.

Alternatively, if the current speed and/or tractive effort does not deviate from the recommended speed and/or tractive effort, then the speed and/or tractive effort of the rail vehicle 100 (shown in FIG. 1) may be sufficiently close to the speed/power profile that the speed and/or tractive profile does not need to be changed. As a result, flow of the method 700 returns to 704, where the speed and/or tractive effort of the rail vehicle 100 is repeatedly compared to the speed/power profile to determine if and when to change the speed and/or tractive effort of the rail vehicle 100.

At 708, the operator 602 (shown in FIG. 6) is tactually prompted with a haptic signal to change the speed and/or tractive effort of the rail vehicle 100 (shown in FIG. 1). For example, the control module 120 (shown in FIG. 1) may communicate an instruction to one or more of the haptic feedback devices 212, 306, 406, 502, 604 (shown in FIGS. 2, 3, 4, 5, and 6). The instruction may direct the haptic feedback devices 212, 306, 406, 502, and/or 604 to provide a haptic signal to the operator 602, such as by vibrating the mass 214, 308, 408, 504, 606 (shown in FIGS. 2, 3, 4, 5, and 6), changing the temperature of the mass 214, 308, 408, 504, 606, changing a physical resistance to moving one or more of the input devices 124, 126, 128 (shown in FIG. 1) in one or more directions, moving one or more of the input devices 124, 126, 128 in one or more directions, and the like. The haptic signal is tactually perceived by the operator 602 such that the operator 602 receives the instruction from the control module 120 to change the speed and/or tractive effort of the rail vehicle 100 without looking away from the rail(s) 106 (shown in FIG. 1) and/or areas outside of the rail vehicle 100.

After 708, flow of the method 700 returns to 704, where the speed and/or tractive effort of the rail vehicle 100 (shown in FIG. 1) is again compared to the speed/power profile. For example, the speed and/or tractive effort of the rail vehicle 100 may be compared to the speed/power profile after the operator 602 (shown in FIG. 6) has been tactually prompted by the control module 120 (shown in FIG. 1) to change the speed and/or tractive effort. The method 700 may continue in a loop-wise manner to ensure that the speed and/or tractive effort of the rail vehicle 100 remains approximately equivalent to the speed/power profile throughout the trip.

According to one embodiment described herein, a tactile prompting system is provided. The tactile prompting system includes a control module that forms an instruction to prompt an operator of a powered rail vehicle to take an action in response thereof, an input device of the powered rail vehicle that is configured to be actuated by the operator, and a haptic feedback device communicatively coupled with the control module and coupled with the input device. The haptic feedback device receives the instruction from the control module and provides a haptic signal to the operator based on the instruction. The haptic signal is tactually perceived by the operator.

In another aspect, the input device is coupled with at least one of a propulsion subsystem or a brake of the powered rail vehicle, the input device being actuated by the operator in response to the haptic signal to change at least one of a tractive effort supplied by the propulsion subsystem or a braking effort supplied by the brake.

In another aspect, the haptic feedback device includes a vibratory mass that moves in response to receiving the instruction. The vibratory mass moves to generate a vibration as the haptic signal.

In another aspect, the haptic feedback device provides a pulse having a plurality of vibrations or changes at least one of a frequency of the vibration, a magnitude of the vibration based on the instruction.

In another aspect, the haptic feedback device includes a thermally conductive body that changes temperature in response to receiving the instruction, the thermally conductive body changing temperature as the haptic signal.

In another aspect, the haptic feedback device varies a physical resistance to actuating the input device in a plurality of directions, the haptic feedback device at least one of reducing the physical resistance to actuating the input device in a first direction or increasing the physical resistance to actuating the input device in a second direction in response to receiving the instruction.

In another aspect, the haptic feedback device moves the input device in a first direction to prompt the operator to move the input device in the first direction.

In another aspect, the input device is one or more of an engine throttle coupled with a propulsion subsystem of the powered rail vehicle or a brake handle coupled with a brake of the powered rail vehicle.

In another aspect, the input device includes a reset actuator that is engaged by the operator to prevent reducing a tractive effort supplied by a propulsion subsystem of the powered rail vehicle or increasing a braking effort supplied by a brake of the powered rail vehicle.

In another aspect, the reset actuator provides the haptic signal to the operator to prompt the operator to engage the reset actuator after a predetermined time as expired since the operator last changed the tractive effort or the braking effort.

In another aspect, the haptic feedback device is wearable on a body of the operator, the haptic feedback device applying the haptic signal to the body of the operator.

In another aspect, the tactile prompting system further includes a physiologic sensor communicatively coupled with the control module, the physiologic sensor measuring a physiologic parameter of the operator and communicating the physiologic parameter to the control module to verify that the operator is in contact with the haptic feedback device.

In another aspect, the control module forms the instruction to direct the operator to respond to a visual instruction presented on a display device of the powered rail vehicle.

Another embodiment described herein provides a tactile prompting method. The method includes determining when to instruct an operator of a powered rail vehicle to take an action related to the rail vehicle, communicating an instruction to a haptic feedback device that is coupled with an input device of the powered rail vehicle, and providing a haptic signal using the haptic feedback device, the haptic signal tactually perceived by the operator to prompt the operator to actuate the input device in response thereto.

In another aspect, the input device is coupled with at least one of a propulsion subsystem or a brake of the powered rail vehicle, the step of determining including determining when to instruct the operator to change at least one of a tractive effort provided to the powered rail vehicle by the propulsion subsystem or a braking effort provided to the powered rail vehicle by the brake.

In another aspect, the step of providing the haptic signal includes vibrating the haptic feedback device.

In another aspect, the step of providing the haptic signal includes providing a pulse of a plurality of vibrations of the haptic feedback device or changing at least one of a frequency or a magnitude of vibrations of the haptic feedback device.

In another aspect, the step of providing the haptic signal includes changing a temperature of the haptic feedback device.

In another aspect, the step of providing the haptic signal includes changing a physical resistance to actuating the input device in at least one of a plurality of directions.

In another aspect, the step of providing the haptic signal includes at least one of reducing the physical resistance to actuating the input device in a first direction or increasing the physical resistance to actuating the input device in a second direction.

In another aspect, the step of providing the haptic signal includes moving the input device in a first direction to prompt the operator to move the input device in the first direction.

In another aspect, the step of providing includes providing the haptic signal to a reset actuator that is engaged by the operator to prevent reducing a tractive effort supplied by a propulsion subsystem of the powered rail vehicle or increasing a braking effort supplied by a brake of the powered rail vehicle.

In another aspect, the step of providing includes providing the haptic signal to direct the operator to respond to a visual instruction presented on a display device of the powered rail vehicle.

In one embodiment, a tangible and non-transitory computer readable storage medium for a tactile prompting system is provided. The computer readable storage medium includes instructions to direct the tactile prompting system to carry out a determination of when to prompt an operator of a powered rail vehicle to take an action; and based on the determination, instruct a haptic feedback device coupled to an input device of the powered rail vehicle to provide a haptic signal that is tactually perceived by the operator, for prompting the operator to take the action.

In another aspect, the input device is coupled with at least one of a propulsion subsystem or a brake of the powered rail vehicle and the instructions direct the tactile prompting system to instruct the haptic feedback device to provide the haptic signal in order to prompt the operator to change at least one of a tractive effort supplied by the propulsion subsystem or a braking effort supplied by the brake.

In another aspect, the instructions direct the tactile prompting system to instruct the haptic feedback device to provide the haptic signal by vibrating.

In another aspect, the instructions direct the tactile prompting system to instruct the haptic feedback device to provide the haptic signal by changing a temperature of the haptic feedback device.

In another aspect, the instructions direct the tactile prompting system to instruct the haptic feedback device to at least one of reduce a physical resistance to actuating the input device in a first direction or increase the physical resistance to actuating the input device in a second direction.

In another aspect, the instructions direct the tactile prompting system to measure a physiologic parameter of the operator to verify that the operator is in contact with the input device.

In another aspect, the instructions direct the tactile prompting system to instruct the haptic feedback device to move the input device in a first direction to prompt the operator to move the input device in the first direction.

In another aspect, the instructions direct the tactile prompting system to instruct the haptic feedback device to provide the haptic signal and prompt the operator to respond to a visual instruction presented on a display device of the powered rail vehicle.

An embodiment relates to a tactile prompting system. The tactile prompting system comprises a control module, an input device, and a haptic feedback device. The control module forms an instruction to prompt an operator of a powered rail vehicle to take a designated action in response thereof, for changing a throttle level and/or breaking level of the vehicle or for otherwise controlling the vehicle. The input device is configured to be actuated by the operator, for controlling the vehicle (e.g., changing the throttle and/or breaking level). The haptic feedback device is communicatively coupled with the control module and coupled with the input device. The haptic feedback device receives the instruction from the control module and provides a haptic signal to the operator based on the instruction. The haptic signal is tactually perceived by the operator, and is provided for prompting the operator to take the designated action in response thereof. For example, the haptic signal may be tactually perceived by the operator through the input device, and in response to tactually perceiving the haptic signal the operator manipulates the input device in a manner indicated by information contained in the haptic signal (which is a function of the instruction of the control module).

In an embodiment, alternatively or in addition to providing a haptic signal to prompt an operator of a rail vehicle to take an action in response thereof for controlling the vehicle (including changing a throttle or breaking level of the vehicle), a haptic signal is provided to convey information to the operator about an operational mode of the rail vehicle (e.g., current throttle or breaking level), including changes in the operational mode of the rail vehicle.

In an embodiment, a vibratory mass is implemented using an electric motor and a metal body attached to an output shaft of the motor in an offset manner, i.e., the weight distribution of the metal body with respect to an axis of the shaft is non-uniform. The metal body is caused to rotate by applying electrical signals to the input of the motor. Because the metal body is offset, its rotation about the shaft cases a vibration, the magnitude and frequency of which are dependent upon the mass of the metal body and the shaft rotation.

As mentioned above, the haptic signal may be a change in temperature of the haptic feedback device 212. In an embodiment, for this purpose, the haptic feedback device comprises a thermoelectric device, which heats up and cools down depending on a polarity of DC current provided to the thermoelectric device.

In an embodiment, a physical resistance to actuating an input device in a plurality of directions may be effectuated using one or more electrically controlled pneumatic cylinders connected to the input device, where an increase in pressure of a pneumatic cylinder (brought about by applying a control signal to the cylinder) increases resistance, and a decrease in pressure decreases resistance.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the disclosed subject matter without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the described subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the described subject matter, including the best mode, and also to enable any person skilled in the art to practice the embodiments of subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A tactile prompting system comprising:
a control module forming an instruction to prompt an operator of a powered rail vehicle to take an action in response thereof;
an input device of the powered rail vehicle, the input device configured to be actuated by the operator; and
a haptic feedback device communicatively coupled with the control module and coupled with the input device, the haptic feedback device receiving the instruction from the control module and providing a haptic signal to the operator based on the instruction, wherein the haptic signal is tactually perceived by the operator.

2. The tactile prompting system of claim 1, wherein the input device is coupled with at least one of a propulsion subsystem or a brake of the powered rail vehicle, the input device actuated by the operator in response to the haptic signal to change at least one of a tractive effort supplied by the propulsion subsystem or a braking effort supplied by the brake.

3. The tactile prompting system of claim 1, wherein the haptic feedback device includes a vibratory mass that moves in response to receiving the instruction, the vibratory mass moving to generate a vibration as the haptic signal.

4. The tactile prompting system of claim 3, wherein the haptic feedback device provides the vibration as a pulse having a plurality of vibration portions or changes at least one of a frequency of the vibration portions or a magnitude of the vibration portions based on the instruction.

5. The tactile prompting system of claim 1, wherein the haptic feedback device includes a thermally conductive body that changes temperature in response to receiving the instruction, the thermally conductive body changing temperature as the haptic signal.

6. The tactile prompting system of claim 1, wherein the haptic feedback device varies a physical resistance to actuating the input device in a plurality of directions, the haptic feedback device at least one of reducing the physical resistance to actuating the input device in a first direction or increasing the physical resistance to actuating the input device in a second direction in response to receiving the instruction.

7. The tactile prompting system of claim 1, wherein the haptic feedback device moves the input device in a first direction to prompt the operator to move the input device in the first direction.

8. The tactile prompting system of claim 1, wherein the input device is one or more of an engine throttle coupled with a propulsion subsystem of the powered rail vehicle or a brake handle coupled with a brake of the powered rail vehicle.

9. The tactile prompting system of claim 1, wherein the input device includes a reset actuator that is engaged by the operator to prevent reducing a tractive effort supplied by a propulsion subsystem of the powered rail vehicle or increasing a braking effort supplied by a brake of the powered rail vehicle.

10. The tactile prompting system of claim 9, wherein the reset actuator provides the haptic signal to the operator to prompt the operator to engage the reset actuator after a predetermined time has expired since the operator last changed the tractive effort or the braking effort.

11. The tactile prompting system of claim 1, wherein the haptic feedback device is wearable on a body of the operator, the haptic feedback device applying the haptic signal to the body of the operator.

12. The tactile prompting system of claim 1, further comprising a physiologic sensor communicatively coupled with the control module, the physiologic sensor measuring a physiologic parameter of the operator and communicating the physiologic parameter to the control module to verify that the operator is in contact with the haptic feedback device.

13. The tactile prompting system of claim 1, wherein the control module forms the instruction to direct the operator to respond to a visual instruction presented on a display device of the powered rail vehicle.

14. A tactile prompting method comprising:
determining when to instruct an operator of a powered rail vehicle to take an action related to the rail vehicle;
communicating an instruction to a haptic feedback device that is coupled with an input device of the powered rail vehicle; and
based on the instruction, providing a haptic signal using the haptic feedback device, the haptic signal tactually perceived by the operator to prompt the operator to actuate the input device in response thereto for taking the action related to the rail vehicle.

15. The tactile prompting method of claim 14, wherein the input device is coupled with at least one of a propulsion subsystem or a brake of the powered rail vehicle, the step of determining including determining when to instruct the operator to change at least one of a tractive effort provided to the powered rail vehicle by the propulsion subsystem or a braking effort provided to the powered rail vehicle by the brake.

16. The tactile prompting method of claim 14, wherein the step of providing the haptic signal includes vibrating the haptic feedback device.

17. The tactile prompting method of claim 16, wherein the step of providing the haptic signal includes providing a pulse of a plurality of vibration portions of the haptic feedback device or changing at least one of a frequency or a magnitude of the vibration portions of the haptic feedback device.

18. The tactile prompting method of claim 14, wherein the step of providing the haptic signal includes changing a temperature of the haptic feedback device.

19. The tactile prompting method of claim 14, wherein the step of providing the haptic signal includes changing a physical resistance to actuating the input device in at least one of a plurality of directions.

20. The tactile prompting method of claim 19, wherein the step of providing the haptic signal includes at least one of reducing the physical resistance to actuating the input device in a first direction or increasing the physical resistance to actuating the input device in a second direction.

21. The tactile prompting method of claim 14, wherein the step of providing the haptic signal includes moving the input device in a first direction to prompt the operator to move the input device in the first direction.

22. The tactile prompting method of claim 14, wherein the step of providing includes providing the haptic signal to a reset actuator that is engaged by the operator to prevent reducing a tractive effort supplied by a propulsion subsystem of the powered rail vehicle or increasing a braking effort supplied by a brake of the powered rail vehicle.

23. The tactile prompting method of claim 14, wherein the step of providing includes providing the haptic signal to direct the operator to respond to a visual instruction presented on a display device of the powered rail vehicle.
